(19) United States
(12) Patent Application Publication
(10) Pub. No.: US 2003/0063259 A1
(43) Pub. Date: Apr. 3, 2003

(54) Methods and apparatus for co-registered motion picture image recording

(76) Inventor: Timothy N. Huber, Ennice, NC (US)

Correspondence Address: SUTHERLAND ASBILL & BRENNAN LLP, 999 PEACHTREE STREET, N.E., ATLANTA, GA, 30309, US

(21) Appl. No.: 10/232,054

(22) Filed: Aug. 30, 2002

Related U.S. Application Data
(60) Provisional application No. 60/316,452, filed on Aug. 31, 2001.
(60) Provisional application No. 60/356,779, filed on Feb. 14, 2002.

(51) Int. Cl. G03B 19/18

(52) U.S. Cl. 352/44

(57) ABSTRACT

A co-registered multi-aperture imaging system is provided, which comprises two or more camera apertures for exposing a light sensitive imaging film or electronic sensor, with each aperture sharing a common perspective; and means for co-registering in time and space light rays of a real image and for directing said light rays to said apertures. The imaging system advantageously can be used to provide extended exposure and creative effects in the visual arts.

### CROSS-REFERENCE TO RELATED APPLICATIONS

Priority is claimed under 35 U.S.C. §119 to U.S. provisional application Serial No. 60/316,452, filed Aug. 31, 2001, and to U.S. provisional application Serial No. 60/356,779, filed Feb. 14, 2002.

### BACKGROUND OF THE INVENTION

This invention is generally in the field motion picture imaging, and more particularly to motion picture special effects.

Motion pictures can be recorded by either film or digital based imaging camera systems. Regardless of format, the photographic principles remain the same: Light rays emanating from an object must be collected by an objective lens and focused on a focal plane containing a light sensitive medium. A shutter mechanism controls the exposure timing and duration, alternately covering and uncovering the open aperture.

In most film motion picture cameras, a rotary shutter spins about a central axis alternately covers and exposes the film, synchronously timed with the film advancement. The exposure duration is a function of the angular size of the open aperture, and the framing rate.

In the case of a digital motion picture imaging system, electronic or mechanical shutters may be used to control the shutter timing and duration. These shutters can be turn off such that the imaging device is recording continuously. In this configuration, timing is controlled by a clock-timing device built into the digital imager.

One embodiment of a prior art shutter assembly is shown in FIG. 1, which illustrates a bow tie shaped shutter assembly having two shutter blades and two apertures. With this shutter arrangement, mirrored shutter blades are used to cover the film plane during film transport, and redirect the image to a viewfinder. Synchronous to the film transport mechanism, the open angular aperture uncovers the film plane, and allows light rays to pass for the exposure. The bow tie shutter alternately covers and exposes two frames for every 360-degree rotation of the shutter assembly.

Another embodiment of a prior art shutter arrangement is shown in FIG. 2, which illustrates a 180-degree half-disk shutter. The shutter rotates in synchronization with the film as the film is transported past the aperture gate at a speed equal to that of the frame rate. Therefore, for one complete rotation of the shutter, one frame is exposed, and the film transported to the next frame.

Modern high performance motion picture cameras have adjustable shutters, as disclosed in U.S. Pat. No. 5,137,346. Typically, the aperture of these shutters has adjustable co-axial blades, providing aperture openings ranging from a maximum of 200 degrees to a minimum of 11.5 degrees. Additionally, these shutters can be adjusted dynamically during camera operation. The adjustment of the shutter during camera operation can coincide with a lens iris change, or a film transport speed change, or a combination of the two.

One of the limitations of these systems is that the shutter has to cover the film gate in order for the film to advance to the next frame. This limits the duration of the exposure to a maximum order of the maximum shutter angle of the motion picture camera divided by 360 degrees times the desired frame rate. This limitation holds true regardless of the frame advance rate. For example, for a motion picture camera with a 200-degree shutter and a frame rate of 24 frames per second (fps), the maximum exposure time per frame is 1/42 second. If the frame rate is 96 fps, then the maximum exposure time per frame is 1/168 second. A charge-coupled device (CCD) also has a maximum exposure duration limitation when used for sequential image recording. With the shutter turn off as described above, a digital motion picture imaging system is capable of exposure durations as long as the inverse of framing rate. At 24 fps, the exposure duration is 1/24 second. It would be desirable to be able to extend the exposure duration of each frame.

U.S. Pat. No. 5,659,323 to Taylor and U.S. Pat. No. 6,052,539 to Latorre disclose a multi-lens, multi aperture array to produce “frozen time” effects. Both of these systems, however, utilize multiple apertures with multiple objective lenses, which cannot occupy the same space. Therefore, any sequence recorded by these systems require a “virtual” dolly move. While in some cases, such a virtual dolly move is desirable, there may be many other instances where the director desires to have the camera remain stationary or to perform a dolly move that is more complex than that afforded by a multi-lens, multi-aperture frozen time camera rig. It would be desirable to provide a means for recording high resolution images, co-registered in both time and space, on multiple image recording media, such as color film and black and white film, or film and video. It would also be desirable to provide a means for recording high definition sequential digital motion picture images at variable and/or high frame rates with high definition slow motion video or other high resolution digital motion picture imaging device, including motion picture imaging systems utilizing CCD's, CMOS chips, or other light sensitive electronic imaging hardware.

### SUMMARY OF THE INVENTION

A co-registered multi-aperture imaging system is provided, which comprises two or more camera apertures for exposing a light sensitive imaging film or electronic sensor, with each aperture sharing a common perspective; and means for co-registering in time and space light rays of a real image and for directing said light rays to said apertures. The imaging system advantageously can be used to provide extended exposure and creative effects in the visual arts.

In a preferred embodiment, each of said two or more apertures corresponds to a single camera, i.e. separate cameras for each aperature. Alternatively, a single camera has the two or more camera apertures and the means for co-registering.

In a preferred embodiment, the means for co-registering comprises one or more beamsplitters for dividing said light rays. For example, at least one beamsplitter divides said light rays into a reflected component and a transmitted component, wherein said reflected component is directed to at least one of said two or more cameras and said transmitted component is directed to at least one other of said two or more cameras. Examples of beamsplitters include plate type beamsplitters, cube type beamsplitters, pellicle type beamsplitters, beamsplitting prism blocks suitable for splitting an image into two or more co-registered images, and combinations thereof. The system may further comprise an objective lens for focusing the light image directed to the means for co-registering, and the means for co-registering may further comprise one or more folding mirrors to maintain the correct orientation of images at the focal planes of each camera.

The cameras of the system can include still cameras, motion picture cameras, or combinations thereof. The cameras can be film-based or can utilize digital imaging devices. The cameras can, for example, be video or HDTV cameras.

The imaging system preferably further comprises adjustable motion picture camera mounts on which the cameras are mounted, for maintaining optical alignment of the cameras. It may further include a rigid support platform on which the adjustable camera mounts are mounted, and may still further include a support device on which the rigid support platform is mounted. Examples of such support devices include dollies, tripods, and camera cranes.

In another aspect, a co-registered multi-aperture motion picture imaging system is provided for producing motion picture images. This system comprises (a) a single objective lens for collecting light rays emanating from a subject to be imaged and for forming a real image; (b) a field lens for collecting the real image formed by the objective lens; (c) beamsplitting means for receiving said real image and producing two or more real images co-registered in time and space; and (d) two or more cameras, each capable of receiving one of said two or more co-registered real images. For example, the cameras could be a film based motion picture camera comprising a lens, a rotary shutter, a film advance mechanism, a light tight magazine that houses a supply and take up spool, and a viewfinder.

In one embodiment, the system includes four cameras, each having an objective lens and each being capable of record sequential images. The four cameras could be arranged such that the beamsplitting means comprises a series of three beamsplitters arranged such that said light rays of the real image are split by a first beamsplitter into a first reflected portion and a first transmitted portion, one of said first portions is then split by a second beamsplitter into a second reflected portion and second transmitted portion, and one of said second portions is then split into a third reflected portion and a third transmitted portion. Preferable, here, the first beamsplitter has a 25/75% reflective/transmissive ratio, the second beamsplitter has a 33/66% reflective/transmissive ratio, and the third beamsplitter has a 50/50% reflective/transmissive ratio. In an alternative arrangement, the four cameras could be positioned such that the beamsplitting means comprises three beamsplitters arranged such that said light rays of the real image are split by a first beamsplitter into a first reflected portion and a first transmitted portion, said first reflected portion is split by a second beamsplitter into a second reflected portion and second transmitted portion, and said first transmitted portion is split by a third beamsplitter into a third reflected portion and a third transmitted portion. Preferably, here, the first beamsplitter, the second beamsplitter, and the third beamsplitter each have a 50/50% reflective/transmissive ratio. In a preferred method of use of the four camera embodiments, sequential frames are recorded, wherein a first camera records the first frame, a second camera records the second frame, a third camera records the third frame, a fourth camera records the fourth frame, the first camera records the fifth frame, the second camera record the sixth frame, the third camera records the seventh frame, the fourth camera records the eighth frame, and subsequent frames are recorded in this pattern with the first, second, third, and fourth cameras.

In one embodiment, the imaging system further includes an electronic control means for providing speed control of the cameras in a synchronous, phase retarded manner. In one embodiment of the imaging system, each camera has a shutter and the cameras operate at the same frame but with their shutters phase retarded such that the apertures are open in a sequential manner. For example, in a four camera system with each camera having a bowtie type rotary shutter, the shutters could be phase retarded by 45 degrees. As another example, in a four camera system with each camera having a half disk type rotary shutter, the shutters could be phase retarded by 90 degrees. The shutters also can be selected, for example, from focal plane shutters, leaf type shutters, and electronic shutters. The system can further include an electronic trigger means for activating the release of the shutters of the cameras.

In another aspect, a method is provided for recording multiple images co-registered in time and space. The method includes providing one of the imaging systems described herein in an operable orientation with a subject to be imaged, and then collecting light rays emanating from the subject and directing the collected light rays to said two or more camera apertures of the imaging system to expose the light sensitive imaging film or electronic sensor with the collected light rays for recording an image of the subject through each aperture.

### BRIEF DESCRIPTION OF THE FIGURES

FIG. 1 depicts a prior art typical bow tie shutter with a total aperture angular size of 200 degrees.

FIG. 2 depicts a prior art typical half disk shutter with a total aperture angular size of 180 degrees.

FIG. 3A and FIG. 3B show a plan view and a perspective view, respectively, of one embodiment of a four-camera array.

FIG. 4 illustrates four 200 degree bow tie shutters phased 45 degrees apart.

FIG. 5 illustrates six 200 degree bow tie shutters phased 30 degrees apart.

FIG. 6 shows a plan view of a second embodiment of a four-camera array.

FIG. 7 depicts a plan view of a two-camera array.

FIG. 8 depicts a plan view of a three-camera array.

FIG. 9 depicts a plan view of a six-camera array.

FIG. 10 depicts a perspective view of a four camera array with optical and camera support.

FIG. 11 depicts one embodiment of an imaging system having a single camera device with multiple apertures.

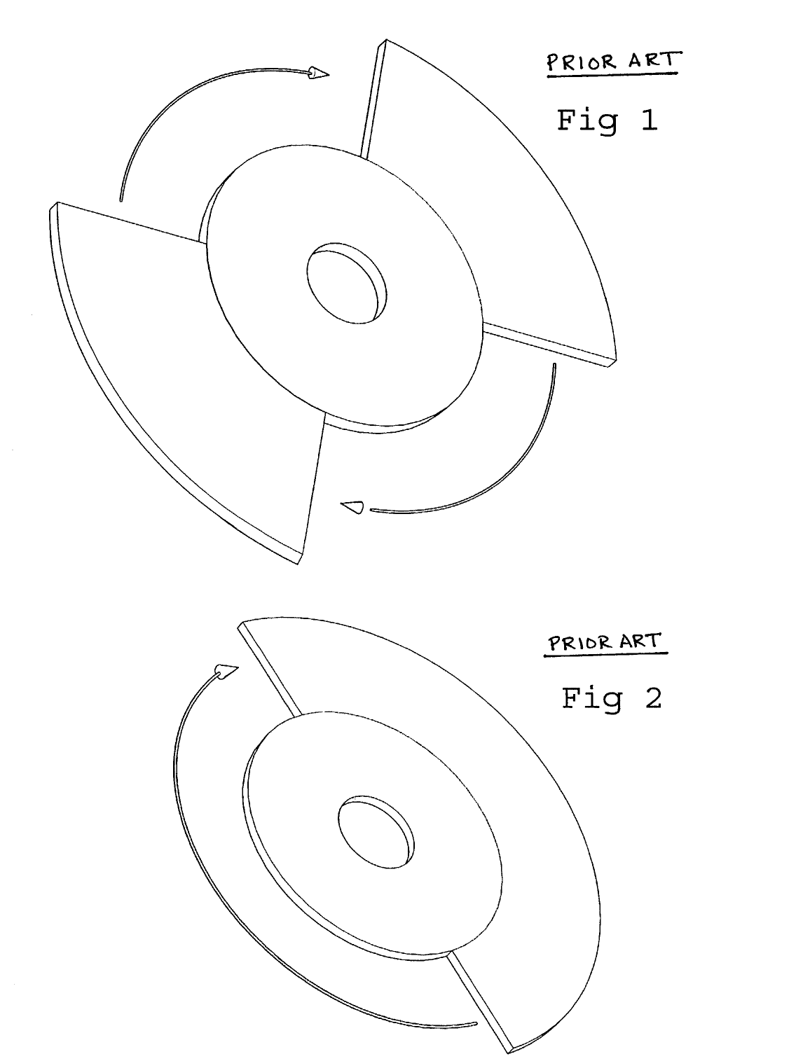

### DETAILED DESCRIPTION OF THE INVENTION

An optical lens assembly has been developed that allows co-registered images to be sequentially recorded by a plurality of image recording devices. The images advantageously are co-registered in both time and space. Therefore, the perspective of the imaged subject is identical among the images. The apparatus and methods of use described herein provide many different methods for forming superimposed sequential and/or alternative images.

The apparatus and methods can utilize different film stocks and film cameras, as well as other recording media and devices, alone or in combination with those for film. Many configurations are possible, and the selection generally depends only on the creative needs and technical requirements of the cinematographer of ordinary skill.

The Imaging System

In one embodiment, the co-registered multi-aperture imaging system comprises: (a) two or more camera apertures for exposing a light sensitive imaging film or electronic sensor, and each aperture sharing a common perspective; and (b) means for co-registering in time and space light rays of a real image and for directing said light rays to said apertures. The two or more camera apertures can be with a single camera device, or each aperture can correspond to separate cameras.

In a preferred embodiment, the imaging system is a motion picture imaging system. In a preferred embodiment, the co-registered multi-aperture motion picture imaging system includes (a) a single objective lens for collecting light rays emanating from a subject to be imaged and for forming a real image; (b) a field lens for collecting the real image formed by the objective lens; (c) beamsplitting means for receiving said real image and producing two or more real images co-registered in time and space; and (d) an array of two or more cameras, each capable of receiving one of said two or more co-registered real images.

As used herein, the term “camera” includes motion picture and still cameras, analog and digital cameras, film-based and electronic imaging devices (e.g., CCDs), video cameras, HDTV, and other image recording devices, unless a particular type of camera or recording media is explicitly indicated. An imaging system can comprise cameras of all the same type or can be comprised of a combination of different types of cameras, depending upon the images or image effects desired.

As used herein, the term “light sensitive imaging film” include any type of know film stock, for either still or motion picture cameras.

As used herein, the term “electronic sensor” includes any type of light sensitive electronic imaging hardware known in the art, including but not limited to charged couple devices (CCDs), CMOS chips, or other electronic devices capable of sensing light rays corresponding to a real image.

As used herein, the term “shutter” includes any type of optical shutter mechanism known in the art, including but not limited to rotary-type shutters, focal plane shutters, leaf type shutters, and electronic shutters.

The means for co-registering and directing the light rays preferably utilizes combinations of known optical hardware to divide the light rays of the image into two or more beams of light, which can then be directed to the camera apertures. Preferably, the means for co-registering and directing sends broadband light to each aperture, i.e. it directs light of the same wavelength to each aperture.

In one embodiment, the means for co-registering comprises one or more beamsplitters. Representative examples of types of suitable beamsplitters include plate type beamsplitters, cube type beamsplitters, pellicle type beamsplitters, and beamsplitting prism blocks suitable for splitting an image into two or more co-registered images. For example, a beamsplitter can divide the light rays into a reflected component and a transmitted component, so that the reflected component can be directed to at least one camera or camera aperture and the transmitted component can be directed to at least one other camera or camera aperture. Additional beamsplitters, e.g., in series with a first one, can be used to further divide the reflected component, the transmitted component or both components. This would be particularly useful with more than two cameras. The means for co-registering and directing the light rays can further comprise one or more lenses or mirrors to focus and change the orientation of the light rays, and thus the image. For example, a folding mirror can be used to maintain the correct orientation of images at the focal planes of each camera.

In a preferred embodiment, the imaging system comprises at least two, and more preferably four, film based motion picture cameras. In one embodiment, the imaging system comprises an array of known film-based motion picture cameras, which typically comprise a lens, a rotary shutter, a film advance mechanism, a light tight magazine that houses a supply and take-up spool, and a viewfinder.

In one embodiment, the system includes a single objective lens, positioned before the co-registering means, with each camera having a secondary objective lens, positioned after the co-registration means. Preferably, this embodiment is used with four or more cameras, each of which is capable of recording sequential images.

In one embodiment, the imaging system further comprises an electronic control means for providing speed control of said cameras in a synchronous, phase retarded manner. Examples of such means are known in the art.

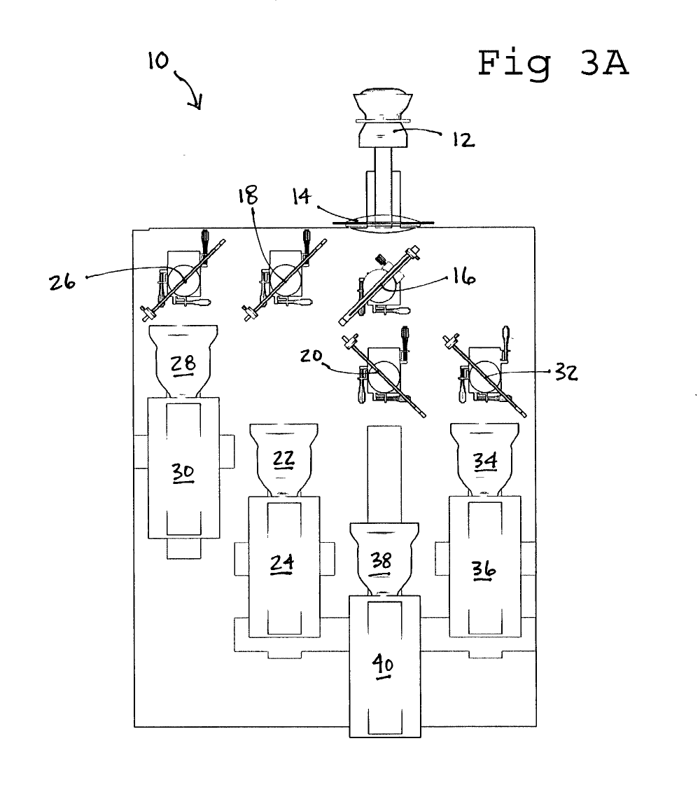

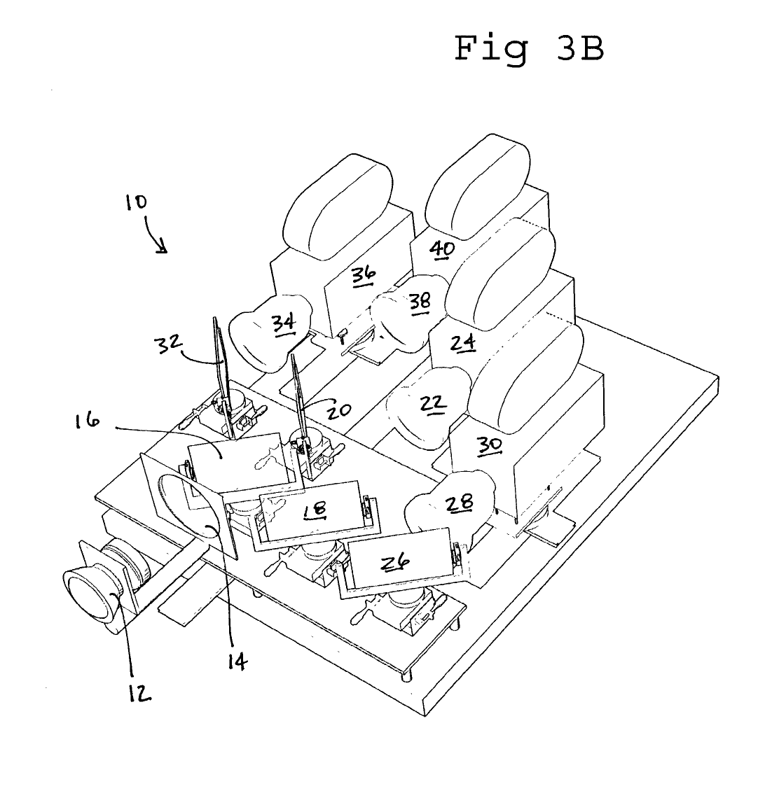

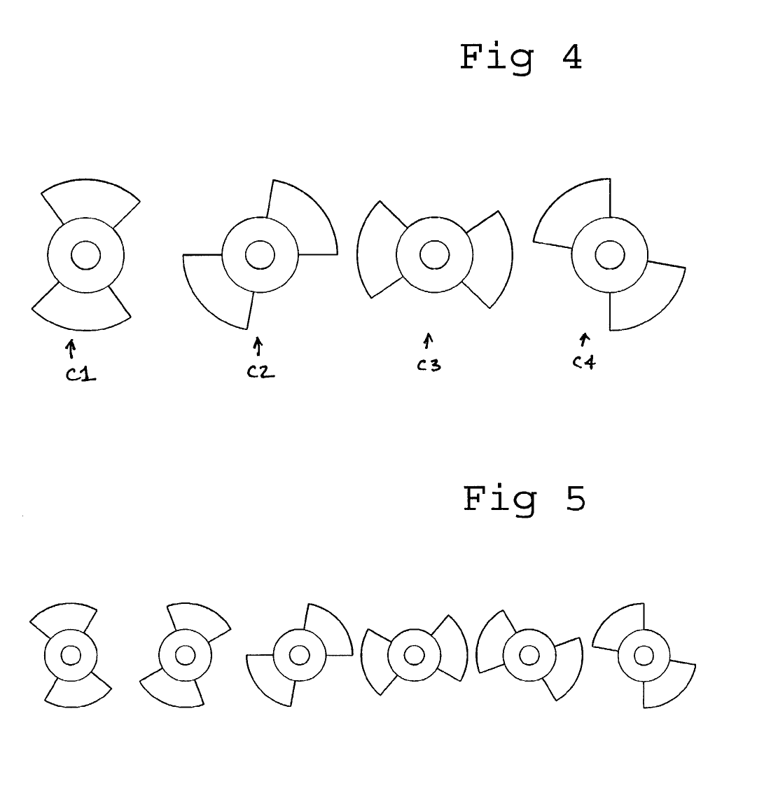

One embodiment of an imaging system is shown in FIG. 3A and FIG. 3B. The imaging system 10 has an interchangeable objective lens 12, mounted to a lens mount. The objective lens 12 collects light emanating from the object being imaged (e.g., filmed) and transfers the light rays along the optical axis, forming a real image collected by a field lens 14. The light rays collected by the field lens 14 continue along an optical path to a 50/50% reflective/transmissive beamsplitter 16, which splits the light rays into reflected and transmitted rays 90 degrees angularly apart. The reflected light rays from beamsplitter 16 proceed to a 50/50% R/T beamsplitter 18, where the light rays are again split into reflected and transmitted rays 90 degrees angularly apart. The transmitted rays from beamsplitter 16 proceed to a 50/50% R/T beamsplitter 20, where the light rays are again split into reflected and transmitted rays 90 degrees angularly apart.

The reflected rays emanating from beamsplitter 18 proceed to an objective lens 22 where they are focused on the focal plane of motion picture recording camera 24. The transmitted rays emanating from beamsplitter 18 proceed to a folding mirror 26, where the rays are folded 90 degrees, then pass to an objective lens 28 where they are focused on the focal plane of motion picture recording camera 30.

The reflected rays emanating from beamsplitter 20 proceed to a folding mirror 32, where the rays are folded 90 degrees, then pass to an objective lens 34 where they are focused on the focal plane of motion picture recording camera 36. The transmitted rays emanating from beamsplitter 20 proceed to an objective lens 38 where they are focused on the focal plane of motion picture recording camera 40.

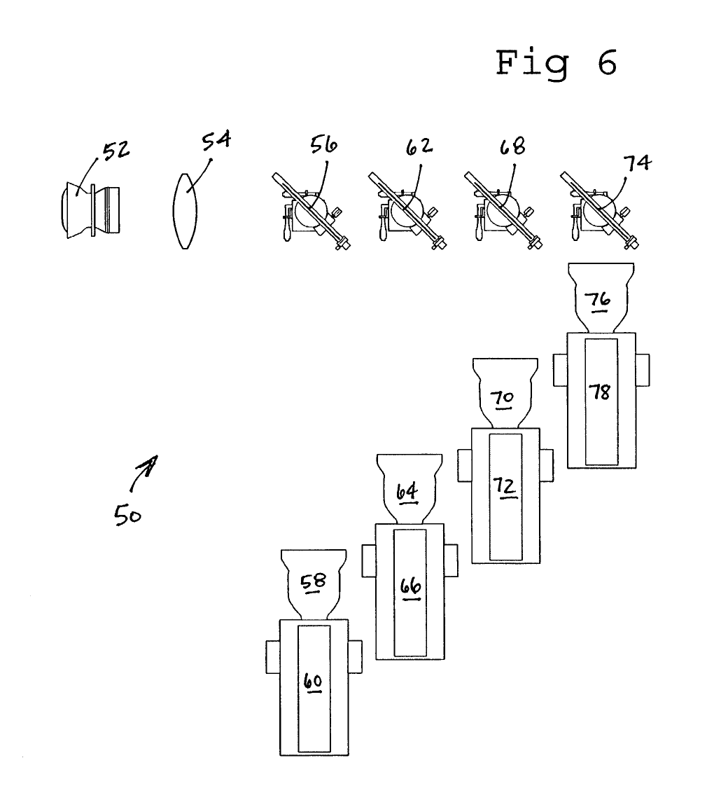

An alternative configuration for a four-camera array is illustrated in FIG. 6. The imaging system 50 has an interchangeable objective lens 52. The objective lens 52 collects light emanating from the object being imaged and transfers the light rays along the optical axis, forming a real image collected by a field lens 54. The light rays collected by the field lens 54 continue along an optical path to a 25/75% reflective/transmissive beamsplitter 56, which splits the light rays into reflected and transmitted rays 90 degrees angularly apart. The reflected rays emanating from beamsplitter 56 proceed to an objective lens 58 where they are focused on the focal plane of motion picture recording camera 60. The transmitted rays from beamsplitter 56 proceed to a 33/66% R/T beamsplitter 62, where the light rays are again split into reflected and transmitted rays 90 degrees angularly apart. The reflected rays emanating from beamsplitter 62 proceed to an objective lens 64 where they are focused on the focal plane of motion picture recording camera 66. The transmitted rays from beamsplitter 62 proceed to a 50/50% R/T beamsplitter 68, where the light rays are again split into reflected and transmitted rays 90 degrees angularly apart. The reflected rays emanating from beamsplitter 68 proceed to an objective lens 70 where they are focused on the focal plane of motion picture recording camera 72. The transmitted rays emanating from beamsplitter 68 proceed to a folding mirror 74, where the rays are folded 90 degrees, then pass to an objective lens 76 where they are focused on the focal plane of motion picture recording camera 78.

Other appropriate beamsplitting ratios can be selected to provide equal light to each camera aperture when greater or less than four cameras are used. One skilled in the art can readily select a variety of configurations of cameras, beamsplitters, folding mirrors, lenses, and other components, for example, depending on the desired creative effects and technical requirements of a particular shot.

Generally, each camera's movement is synchronized to one camera in the array using a synchronization device, such as those known for use in multiple camera shots such as special effects shots, stunts, and the like.

In one embodiment, each camera of the imaging system has a shutter and the cameras operate at the same frame but with their shutters phase retarded such that the apertures are open in a sequential manner. Typically, the shutters are phase retarded a number of degrees using the formula:

$$Degrees = \frac{360}{n} \times \frac{1}{a}$$

where n=the number of cameras in the system, and

where a=the number of open apertures in the shutter of one the cameras.

For extended exposure duration, the shutter/frame advance is phased so that camera one records frame one, then camera two records frame two, camera three records frame three, camera four records frame four, camera one records frame five, and so on. For example, if the desired total frame rate is 24 frames per second (fps), and a four-camera array is chosen for creative purposes, then each camera would operate at six fps, for a total of 24 fps. Camera one is the master, providing a synchronization signal to the other three cameras. This signal provides a means for synchronizing the operational speed of multiple motion picture cameras.

In a four-camera array with identical motion picture cameras using a bow tie shutter arrangement, cameras C2, C3, and C4 are synchronized to the movement of camera C1, as illustrated in FIG. 4. The shutter of C2 is retarded 45 degrees from the shutter of C1; the shutter of C3 is retarded 90 degrees from the shutter of C1; the shutter of C4 is retarded 135 degrees from the shutter of C1. Similarly, in a single aperture shutter arrangement (e.g., a half disk shutter) which is not shown, cameras C2, C3, and C4 would be synchronized to the movement of camera C1, 90 degrees retarded from the previous camera in the array. FIG. 5 illustrates six 200 degree bow tie shutters phased 30 degrees apart.

Phase retardation is accomplished by first establishing a synchronized array, whereas each camera runs in exact synchronization, then manipulating the phase of each camera to the desired phase. The technique of synchronizing multiple cameras is apparent to those skilled in the art of multi-camera cinematography.

In a four-camera array running at 24 fps, ten seconds of run time would produce 240 frames from four cameras running at 6 fps. After the film is processed, the frames would be edited in postproduction as follows:

| Frame # | Originating Camera |
|---|---|
| 1 | C1 frame 1 |
| 2 | C2 frame 1 |
| 3 | C3 frame 1 |
| 4 | C4 frame 1 |
| 5 | C1 frame 2 |
| 6 | C2 frame 2 |
| 7 | C3 frame 2 |
| 8 | C4 frame 2 |
| 9 | C1 frame 3 |

and so on for each frame.

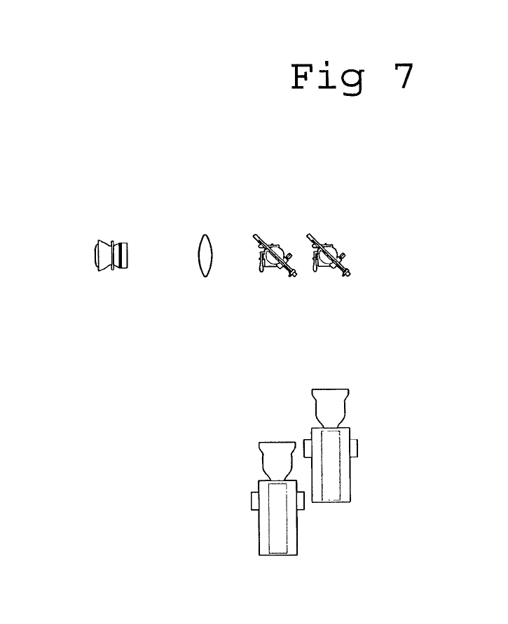

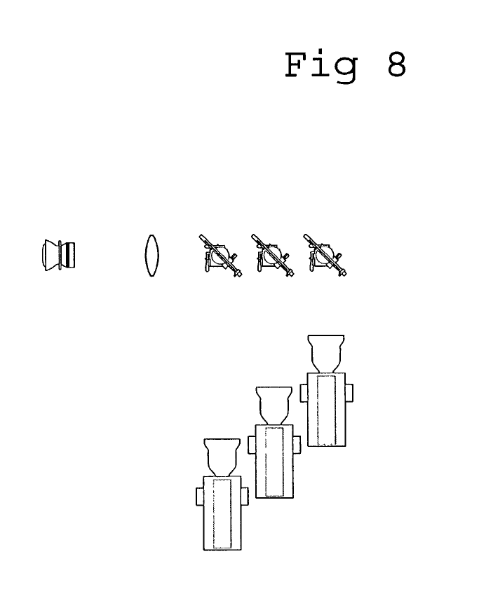

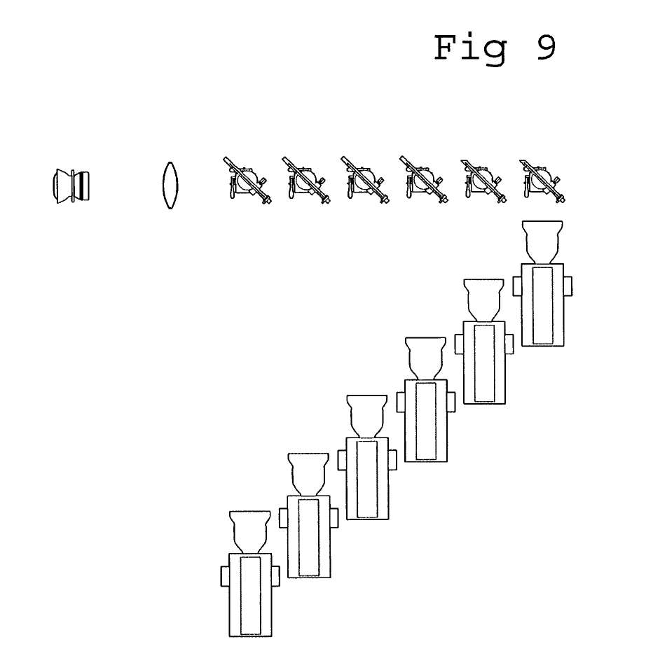

To illustrate the extended exposure possible with the present imaging system, consider that a currently available camera operating at 24 fps at a maximum shutter angle of 200 degrees has an exposure duration of 1/44 sec. (0.0227 sec.). In contrast, a four-camera array as described herein could allow the maximum exposure time for each frame to be 1/11 sec. (0.0926 sec). Thus, the four-camera array provides a two stop gain in maximum exposure time over a normal motion picture camera running at the same total frame rate. With a four-camera array operating at a total frame rate of 24 fps, and utilizing 180-degree shutters, two seconds of exposure are recorded in a single second. A two-camera array can provide a one stop gain, and a three-camera array can provide a 1½ stop gain. Similarly, a six-camera array can provide a 2½ stop gain in maximum exposure time. Each doubling of the number of cameras results in a one stop gain in maximum exposure time. FIG. 7, FIG. 8, and FIG. 9 illustrate possible embodiments of two, three, and six camera arrays, respectively.

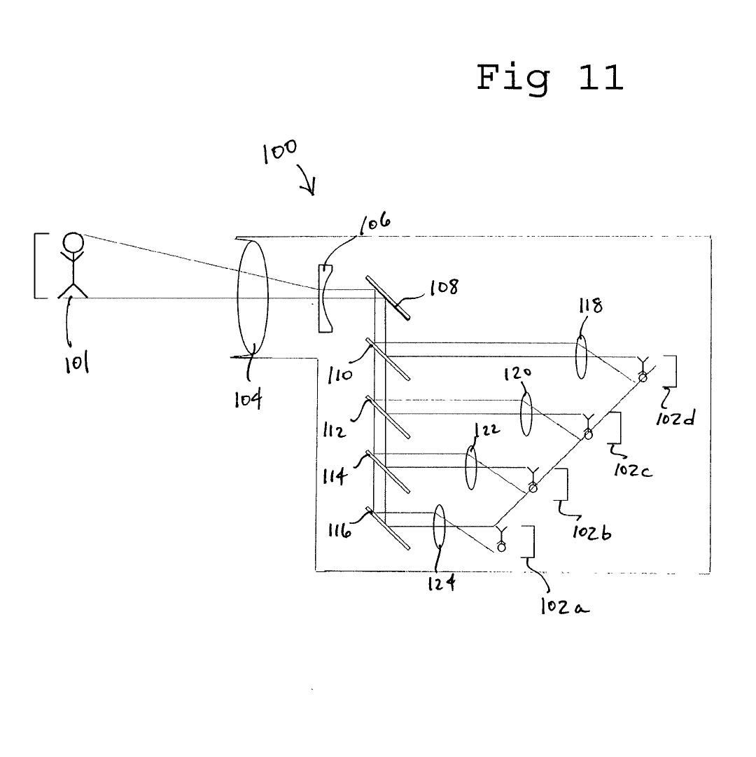

In another embodiment, the imaging system is a single device having a plurality of common apertures and a plurality of film movements, allowing for a plurality of film “reels” to be loaded into a single, coherent device. This type of system would have the same capability of splitting a beam into equal components, as described above. All of the synchronization control could be built into the electronics of the camera. In yet another embodiment, the imaging system is a single camera having a plurality of common apertures and having a plurality of CCDs or other digital recording device such as CMOS chips as the recording medium. FIG. 11. illustrates these embodiments generically, showing single camera device 100 having four camera apertures 102a, 102b, 102c, and 102d. and showing the optical path that the light rays take from subject 101 to the apertures. The device 100 includes objective lens 104; field or relay lenses 106, 118, 120, 122, and 124; folding mirrors 108 and 116; and beamsplitters 110, 112, 114, and 116. The recording device (e.g., film, CCD, etc.) on the other side of the apertures is not shown in this Figure.

Ancillary Components of the Imaging System

Typically, the (film or video) camera is mounted on a support structure (a so-called camera “head”), which is manually manipulated to point the camera at an object (i.e. the subject of the image to be recorded) and to pan and tilt the camera as needed (e.g., as the object moves) or as otherwise desired. The support structure can also be selected from other support devices used in the art, such as a dolly, a tripod, or a camera crane.

In a preferred embodiment, the imaging system is provided with a means to facilitate optical alignment of each camera. For example, a camera support mechanism can be provided that will allow each camera to be held in optical alignment, as well as to allow the entire assembly to be mounted on a support structure, such as a camera head. Adjustable camera mounts can be used to maintain the optical alignment. In one embodiment, each camera is secured to an x-y axis translation stage, and each translation stage is mounted to a optical rail, providing for/aft adjustability.

In one embodiment of an imaging system that uses cube beam splitters, the cameras are mounted to x-y axis translation stages, which are then mounted to a rigid optical breadboard. This breadboard can then be mounted to a support device such a camera head. One skilled in the art can, of course, select essentially any combination of known opto-mechanical hardware components to mount the components of the means for co-registering and directing light rays with respect to one another and to control the positioning and movement of the assembly (i.e. the system) in any direction (linear or angular) with respect to the object being filmed (or taped or photographed, etc.).

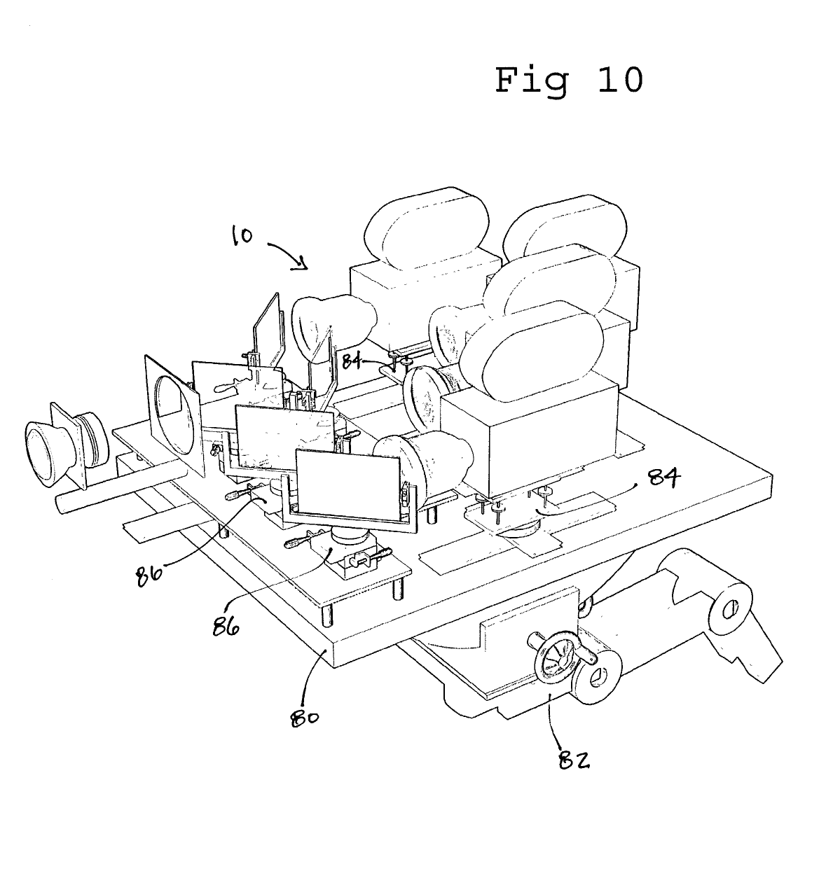

FIG. 10 illustrates imaging system 10 (described above and in FIGS. 3A-B) mounted on a rigid support platform 80, which is, in turn, mounted to a dolly 82. It can be seen that the cameras are mounted onto the rigid support platform 80 with adjustable motion picture camera mounts 84. Optical support hardware 86 is shown for maintaining optical alignment of the folding mirrors and beamsplitters of the imaging system.

Optionally, some or all of the various beam splitters, collimating relay lenses, reimaging relay lenses, and/or light folding mirrors can be provided within a protective cover to reduce the accumulation of dust or other matter on these optical components and other interferences with the light received by the recording devices.

Other Uses of the Imaging System

In one embodiment, the imaging system includes a computer-controlled exposure control feature that can dynamically alter the exposure timing and duration. This system could work with both stroboscopic and ambient lighting. Strobes have very short exposure durations, anywhere from 1/500 s to 1/100,000 s or faster. In still photography, photographers create certain special effects by using a long ambient light exposure, and popping a strobe light right before the shutter closes. This is called rear curtain sync, or tail sync, and the effect is a motion blur led by a sharp image. In a preferred embodiment, the imaging system described herein can provide the opportunity for rear curtain or tail sync effect in motion picture imaging by providing an exposure duration long enough to provide the motion blur component. In this embodiment, the strobe trigger would be synchronized to the opening of the aperture by the shutters. Frames actually overlap in time when the system is used for extended exposure duration effects. A strobe firing at the “rear curtain” of one frame will also appear at the beginning of the next frame, providing two strobe “pops” per frame, with motion blur between the two strobe pops.

In another embodiment, each camera of the imaging system is operated at its own frame rate and shutter angle, without any attempt to synchronize the frame rates. This would provide for co-registered footage shot at different frame rates. This can be used for creative effect by the cinematographer or director.

In another embodiment, different film stock loads, filtration, processing techniques, or another creative effect are used for each camera in the array. Therefore, in editing, fades or jump cuts from one camera's footage to another would yield an interesting creative effect.

Modifications and variations of the methods and devices described herein will be obvious to those skilled in the art from the foregoing detailed description. Such modifications and variations are intended to come within the scope of the appended claims.

We claim:

1. A co-registered multi-aperture imaging system comprising:
two or more camera apertures for exposing a light sensitive imaging film or electronic sensor, and each aperture sharing a common perspective; and
means for co-registering in time and space light rays of a real image and for directing said light rays to said apertures.

2. The system of claim 1, wherein the means for co-registering comprises one or more beamsplitters for dividing said light rays.

3. The system of claim 1, further comprising an objective lens for focusing the light image directed to the means for co-registering.

4. The system of claim 1, wherein each aperture of said two or more camera apertures corresponds to a separate camera.

5. The system of claim 4, comprising at least four cameras.

6. The system of claim 4, wherein at least two of the cameras are each film-based motion picture cameras.

7. The system of claim 4, wherein at least two of the cameras are each video cameras.

8. The system of claim 4, wherein at least two of the cameras each comprise a digital motion picture imaging device.

9. The system of claim 4, wherein at least two of the cameras each comprise a still camera.

10. The system of claim 2, wherein said at least one beamsplitter divides said light rays into a reflected component and a transmitted component, wherein said reflected component is directed to at least one of said two or more cameras and said transmitted component is directed to at least one other of said two or more cameras.

11. The system of claim 10, wherein the beamsplitter is selected from the group consisting of plate type beamsplitters, cube type beamsplitters, pellicle type beamsplitters, and combinations thereof.

12. The system of claim 2, wherein said at least one beamsplitter comprises a beamsplitting prism block suitable for splitting an image into two or more co-registered images.

13. The system of claim 2, wherein the means for co-registering further comprises one or more folding mirrors to maintain the correct orientation of images at the focal planes of each camera.

14. The system of claim 4, further comprising adjustable motion picture camera mounts on which said cameras are mounted, for maintaining optical alignment of said cameras.

15. The system of claim 14, further comprising a rigid support platform on which said adjustable camera mounts are mounted.

16. The system of claim 15, further comprising a support device on which the rigid support platform is mounted, wherein the support device is a dolly, a tripod, or a camera crane.

17. The system of claim 4, further comprising an electronic control means for providing speed control of said cameras in a synchronous, phase retarded manner.

18. The system of claim 1, wherein a single camera has the two or more camera apertures and the means for co-registering.

19. A co-registered multi-aperture motion picture imaging system for producing motion picture images comprising:
a single objective lens for collecting light rays emanating from a subject to be imaged and for forming a real image;
a field lens for collecting the real image formed by the objective lens;
beamsplitting means for receiving said real image and producing two or more real images co-registered in time and space; and
two or more cameras, each capable of receiving one of said two or more co-registered real images.

20. The system of claim 19, further comprising optical support hardware for maintaining optical alignment of the beamsplitter means.

21. The system of claim 19, further comprising one or more folding mirrors for maintaining the correct orientation of real images at the focal planes of said cameras.

22. The system of claim 21, further comprising optical support hardware for maintaining optical alignment of the folding mirrors.

23. The system of claim 19, further comprising adjustable motion picture camera mounts on which said cameras are mounted, for maintaining optical alignment of said cameras.

24. The system of claim 23, further comprising a rigid support platform on which said adjustable camera mounts are mounted.

25. The system of claim 24, further comprising a support device on which the rigid support platform is mounted, wherein the support device is a dolly, a tripod, or a camera crane.

26. The system of claim 19, further comprising an electronic control means for providing speed control of said cameras in a synchronous, phase retarded manner.

27. The system of claim 19, wherein each of said two or more cameras is a film based motion picture camera comprising a lens, a rotary shutter, a film advance mechanism, a light tight magazine that houses a supply and take up spool, and a viewfinder.

28. The system of claim 19, wherein said two or more cameras are selected from the group consisting of digital motion picture imaging devices, film-based motion picture imaging cameras, film still cameras, digital still cameras, and combinations thereof.

29. The system of claim 19, wherein the beam splitter is selected from the group consisting of plate type beam splitters, cube type beam splitters, pellicle type beam splitters, and combinations thereof.

30. The system of claim 19, comprising four cameras, wherein each camera comprises an objective lens and each camera can record sequential images.

31. The system of claim 30, wherein the beamsplitting means comprises a series of three beamsplitters arranged such that said light rays of the real image are split by a first beamsplitter into a first reflected portion and a first transmitted portion, one of said first portions is then split by a second beamsplitter into a second reflected portion and second transmitted portion, and one of said second portions is then split into a third reflected portion and a third transmitted portion.

32. The system of claim 31, wherein the first beamsplitter has a 25/75% reflective/transmissive ratio, the second beamsplitter has a 33/66% reflective/transmissive ratio, and the third beamsplitter has a 50/50% reflective/transmissive ratio.

33. The system of claim 30, wherein the beamsplitting means comprises three beamsplitters arranged such that said light rays of the real image are split by a first beamsplitter into a first reflected portion and a first transmitted portion, said first reflected portion is split by a second beamsplitter into a second reflected portion and second transmitted portion, and said first transmitted portion is split by a third beamsplitter into a third reflected portion and a third transmitted portion.

34. The system of claim 33, wherein the first beamsplitter, the second beamsplitter, and the third beamsplitter each have a 50/50% reflective/transmissive ratio.

35. The system of claim 30, for recording sequential frames, wherein a first camera records the first frame, a second camera records the second frame, a third camera records the third frame, a fourth camera records the fourth frame, the first camera records the fifth frame, the second camera record the sixth frame, the third camera records the seventh frame, the fourth camera records the eighth frame, and subsequent frames are recorded in this pattern with the first, second, third, and fourth cameras.

36. The system of claim 19, wherein each camera has a shutter and the cameras operate at the same frame but with their shutters phase retarded such that the apertures are open in a sequential manner.

37. The system of claim 36, wherein the shutters are phase retarded a number of degrees using the formula:
$$Degrees = \frac{360}{n} \times \frac{1}{a}$$
where n=the number of cameras in the system, and
where a=the number of open apertures in the shutter of one the cameras.

38. The system of claim 36, having four cameras wherein the shutters are phase retarded by 45 degrees and each camera has a bowtie type rotary shutter.

39. The system of claim 36, having four cameras wherein the shutters are phase retarded by 90 degrees and each camera has a half disk type rotary shutter.

40. The system of claim 36, where the cameras comprise video cameras.

41. The system of claim 36, wherein the cameras comprise still cameras.

42. The system of claim 36, further comprising an electronic trigger means for activating the release of the shutters of the cameras.

43. The system of claim 36, wherein the shutter is selected from the group consisting of rotary shutters, focal plane shutters, leaf type shutters, and electronic shutters.

44. A method of recording multiple images co-registered in time and space comprising:
providing the imaging system of claim 1 in an operable orientation with a subject to be imaged; and
collecting light rays emanating from the subject and directing the collected light rays to said two or more camera apertures of the imaging system to expose the light sensitive imaging film or electronic sensor with the collected light rays for recording an image of the subject through each aperture.

45. The method of claim 44, wherein the imaging system comprises two or more motion picture cameras.
